(19) United States
(12) Patent Application Publication
(10) Pub. No.: US 2010/0304019 A1
(43) Pub. Date: Dec. 2, 2010

(54) POLARIZING COATINGS HAVING IMPROVED QUALITY

(76) Inventors: Pierre-Jean Baron, Bois Le Roi (FR); Jerome Vivien Davidovits, Thomery (FR); Bruno Dufour, Champagne sur Seine (FR); Frank Duraes, Dordives (FR); Eric Gesell, Chaintreaus (FR); Philippe Sinard, Cesson (FR)

Correspondence Address: CORNING INCORPORATED, SP-TI-3-1, CORNING, NY, 14831, US

(21) Appl. No.: 12/474,978

(22) Filed: May 29, 2009

(51) Int. Cl. G02B 1/10

(52) U.S. Cl. 427/163.1

(57) ABSTRACT

A method for preparing a polarizing substrate comprising a dye layer in which the substrate is contacted with a first solution having a organic silane at a temperature greater than room temperature.

### TECHNICAL FIELD

This disclosure relates to lens substrates, polarizing coatings, polarizing articles, and to methods of preparing polarizing coatings on a substrate.

### BACKGROUND

Polarized filters selectively absorb reflected glare while transmitting useful light. Such articles are used in various fields such as, for example, ophthalmic lenses, solar protection glasses, filters, and the like. Polarizing lenses have a unique ability to selectively eliminate glare that is reflected from smooth horizontal surfaces, such as water or ice. Polarized filters also can selectively absorb the reflected glare while transmitting the useful light.

Polarizing articles may be prepared by depositing a layer comprising liquid crystal dyes directly on a substrate. These dyes generally may be water soluble and sensitive to environmental conditions, necessitating the addition of several protective layers to produce a finished article. The additional layers decrease the mechanical integrity of the dye layer by inducing cracks in the dye layer, leading to diminished cosmetic qualities.

### SUMMARY

This disclosure includes a method of preparing a polarizing article having high polarization efficiency, low haze, less visible micro-cracks, and environmental stability. For example, such articles are more resistant to delamination of the lens coatings. An article can be made by applying an aqueous polarizing dye solution to a surface of a substrate. The polarizing dye solution can comprise a single ammonium salt of a polarizing azoic dye and an activator.

One specific embodiment includes a method of making a polarizing article having improved polarization efficiency. The method comprises the steps of:
providing a light-transmitting substrate;
providing an aqueous polarizing dye solution;
coating at least one surface of the substrate with the aqueous polarizing dye solution to form a polarizing coating;
insolubilizing the polarizing coating with a stabilizing solution;
treating the insolubilized polarizing coating with an aqueous silane solution at an elevated temperature or at a temperature greater than room temperature (e.g. greater than about 20 degrees Celsius); and
curing the solution treated polarizing coating to form the polarized article.

In another specific embodiment, the dye solution has a salt of a single azoic polarizing dye and an activator, wherein the activator can be a non-ionic surfactant.

Another specific embodiment includes a polarizing article. A polarizing article may have a light-transmitting substrate and a polarizing coating disposed on at least one surface of the substrate, the polarizing coating comprising a single polarizing azoic dye and a stabilizer.

### BRIEF DESCRIPTION OF THE DRAWINGS

FIG. 1A is a photographic image of a polarized lens in which the lens was exposed to a silane solution at 50 degrees Celsius.

FIG. 1B is a photographic image of a second polarizing lens in which the lens was exposed to a silane solution at 50 degrees Celsius.

FIG. 2A is a photographic image of a polarizing lens prepared using a commercial dye solution.

FIG. 2B is a photographic image of a polarizing lens prepared using another polarized dye solution.

FIG. 2C is a photographic image of a polarizing prepared lens using another polarized dye solution.

FIG. 2D is a photographic image of a polarizing prepared using a polarized dye solution.

### DETAILED DESCRIPTION

Specific embodiments relate to methods useful to prepare polarizing articles having high polarization efficiency, low haze and environmental stability. Such methods may provide polarizing articles with protection against delamination of the layers in solutions, such as water. Exemplary articles may be suitable for the manufacturing of ophthalmic polarizing lenses and/or sunglasses having polarizing lenses using plastics or mineral (i.e., glass) substrates. In some specific embodiments, the polarized lens can exhibit optimized polarization efficiency, transmission, haze, cosmetic quality, stability, and/or scratch resistance.

An aqueous polarizing dye solution for use with specific embodiments can include a polarizing dye solution having a salt (e.g. an ammonium salt) of a single polarizing azoic dye and a non-ionic surfactant that serves as an activator. The dye solution, when used to form a polarizing coating on a substrate, forms a polarizing film that has less haze, as measured by ASTM Standard Test Method for Haze D 1003-07 (also referred to herein as “ASTM haze”), higher polarization efficiency, and less micro-cracking than polarizing coatings that are formed using other vehicles.

In one specific embodiment, exposing a lens to a silane solution at an elevated temperature allows for the use of one polarizing azoic dye in the aqueous dye solution. The polarizing azoic dye can be present in the solution in a range from about 1% up to about 8% by weight. Dye concentrations that are in excess of this range can result in thicker polarized coatings, whereas dye concentrations that are below this range can produce polarizing coatings that have unsatisfactorily low polarization efficiencies.

One specific embodiment includes a method for preparing a polarizing lens comprising a dye layer, in which the lens can be exposed to a solution having a first organic silane with one or more reactive functional group. For example, such silanes can have functional group such as an amino group, a thiol group, a hydroxyl group, a carboxyl group, an acrylic acid, an organic and inorganic acid, an ester, an anhydride, an aldehyde, an epoxide, derivatives or salts thereof, and combinations thereof The silane may be a straight or branched-chain aminosilane, aminoalkoxysilane, aminoalkylsilane, aminoarylsilane, aminoaryloxysilane, derivatives thereof, or salts thereof. Specific examples of suitable silanes include 3-aminopropyl trimethoxysilane, 3-aminopropyl triethoxysilane, N-(beta-aminoethyl)-3-aminopropyl trimethoxysilane, N-(beta-aminoethyl)-3-aminopropyl triethoxysilane, N′-(beta-aminoethyl)-3-aminopropyl methoxysilane, or aminopropylsilsesquixoane.

In another embodiment, the first solution can be applied to the lens at a temperature greater than room temperature (e.g. greater than about 20-25 degrees Celsius). In another embodiment, the first solution can be applied to the lens at a temperature greater than about 30 degrees Celsius. In another embodiment, the first solution can be applied to the lens at a temperature greater than about 50 degrees Celsius. In one example, the substrate was dipped in an aqueous solution containing about 10% by weight of 3-aminopropyltrisethoxysilane for 15 minutes after coating the surface of the substrate with the polarizing dye solution.

Exemplary precipitated salts of polarizing azoic dyes may still have an unacceptable level of solubility in water at high temperature or may be mobilized after prolonged exposure to sweat. Thus, the method, in some embodiments, may further comprise additional immobilization of the polarizing azoic dye molecules. The polarizing coating or layer can be washed with an aqueous solution comprising at least one of a silane, a siloxane, or a prepolymer of at least one siloxane. The silane can be one of a straight or unbranched chain aminosilane, a branched-chain aminosilane, an aminoalkoxysilane, an aminoalkylsilane, an aminoarylsilane, an aminoaryloxysilane, an epoxyalkyltrialkoxysilane, combinations thereof, derivatives thereof, and salts thereof

Examples of such siloxanes and/or silanes include 3-aminopropyltriethoxysilane, 3-aminopropyltrimethoxysilane, 3-aminopropyltrichlorosilane, 3-aminopropylalkoxysilane, γ-glycidoxypropyltrimethoxysilane, γ-glycidoxypropylpentamethyldisiloxane, γ-glydicoxypropylmethyldiisopropenoxysilane, (γ-glycidoxypropyl)methyldiethoxysilane, γ-glycidoxypropyldimethylethoxysilane, γ-glycidoxypropyldiisopropylethoxysilane, (γ-glycidoxypropyl)bis(trimethylsiloxy)methylsilane, and combinations thereof

Following the contact with the silane solution, the article can be rinsed in deionized water, dried and cured. In one embodiment, the article can be dried by blowing pressurized nitrogen or air over the surface of the article. Articles comprising a glass substrate are, in one embodiment, cured by heating at 125° C. for 30 minutes, whereas, in another embodiment, lenses comprising a plastic substrate are cured by heating at 60° C. for 60 minutes. Haze and polarization efficiency of the thus-treated polarizing coating are typically measured after the coating has dried.

The aqueous polarizing dye solution may have from about 0.01% up to about 10% activator by weight. In one embodiment, the dye solution comprises from about 0.02% up to about 5% activator by weight and, in yet another embodiment, from about 0.04% up to about 1% activator by weight.

In one specific embodiment, the polarizing azoic dye may be a dichroic dye. A single dichroic dye may be used to provide the polarizing effect as well as a desired color or tint to a polarizing article. Alternatively, a solution comprising a combination of such dyes, such as, but not limited to, red, yellow, or blue dyes, may be used to achieve the desired polarization effect and color to the final product.

The polarizing azoic dye may be selected from water soluble “direct” dyes, such as those described in U.S. Pat. No. 5,639,809, entitled “Azo Compounds and Polarizing Films Using the Compounds,” by Yoriaki Matsuzaki et al., filed on Jun. 14, 1995; U.S. Pat. No. 7,108,897, entitled “Dye Type Polarizing Plate,” by Shoji Oiso et al., filed Jul. 26, 2004; U.S. Pat. No. 2,400,877, entitled “Optical Device and Method and Manufacture Thereof,” by Joseph F. Dreyer, filed on Mar. 21, 1961; and International Application WO 00/22463, entitled “Guest-Host Polarizers,” by Hassan Sahouani, having a priority date of Oct. 14, 1998. In some embodiments, the solubility of the dye is less than 5% at room temperature.

Examples of the polarizing azoic dye include C.I. (Color Index) Direct Blue 67, C.I. Direct Blue 90, C.I. Direct Green 59, C.I. Direct Violet 48, C.I. Direct Red 39, C.I. Direct Red 79, C.I. Direct Red 81, C.I. Direct Red 83, C.I. Direct Red 89, C.I. Direct Orange 39, C.I. Direct Orange 72, C.I. Direct Yellow 34, C.I. Direct Green 26, C.I. Direct Green 27, C.I. Direct Green 28, C.I. Direct Green 51, and combinations thereof The structures of these dyes that are known in the art are listed in Table 1. In one non-limiting example, the polarizing dye solution comprises ammonium salts of C.I. Direct Blue 67, C.I. Direct Orange 72, and C.I. Direct Green 27.

Other salts, such as sodium salts, potassium salts, and the like, of the polarizing azoic dye may be substituted for a portion of the ammonium salt of the dye. The ammonium salt comprises at least 50% by weight of the total amount of salt added for a particular dye. Whereas crude, unpurified salts of the polarizing azoic dyes may be used, the salts may be purified by those methods known in the art.

In another embodiment, a substrate with polarized layers can have cosmetic quality through the selection of specific polarizing dyes. The use of a polarizing dye, alone or mixed with particular dyes, enhances mean transmission and drastically improves the cosmetic quality by preventing the formation of defects in the polarizing dye layer leading to micro-cracks or specters without deteriorating the other attributes, including high polarization efficiency and low haze.

TABLE 1

| | |
|---|---|
| C.I. Direct Blue 67 | 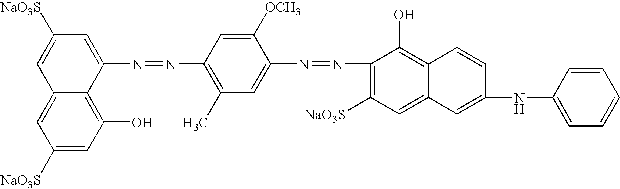 |
| C.I. Direct Orange 72 | 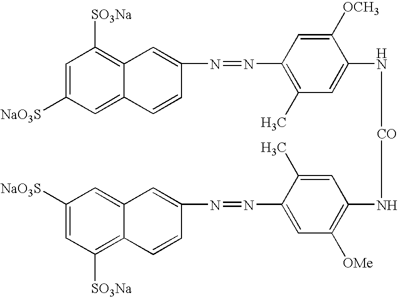 |
| C.I. Direct Red 83 | 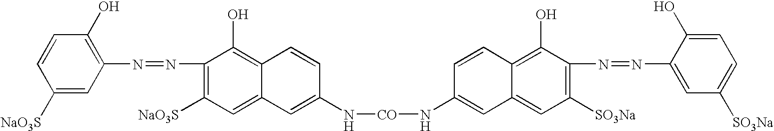 |
| C.I. Direct Green 59 | 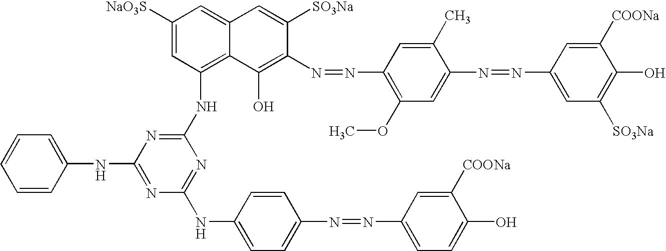 |
| C.I. Direct Violet 48 | 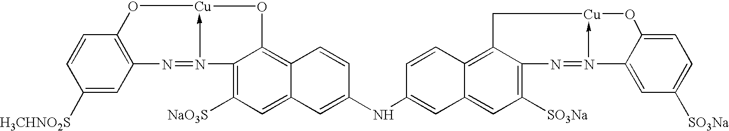 |
| C.I. Direct Yellow 34 | 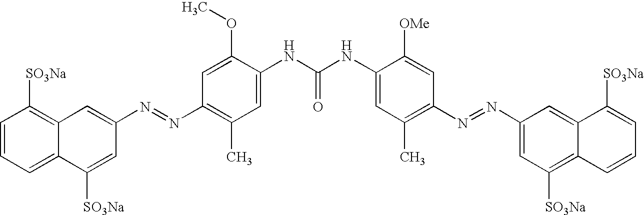 |
| C.I. Direct Green 26 | 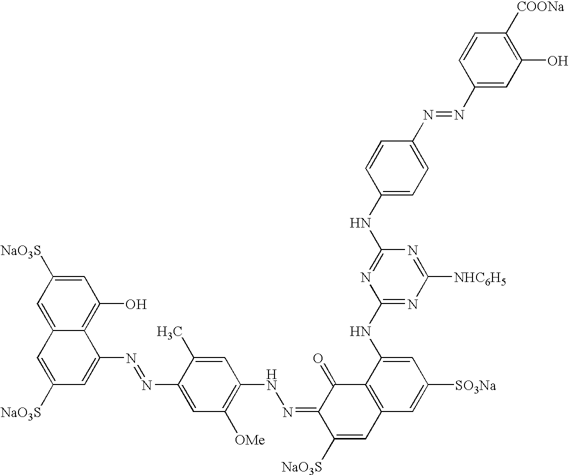 |
| C.I. Direct Green 51 | 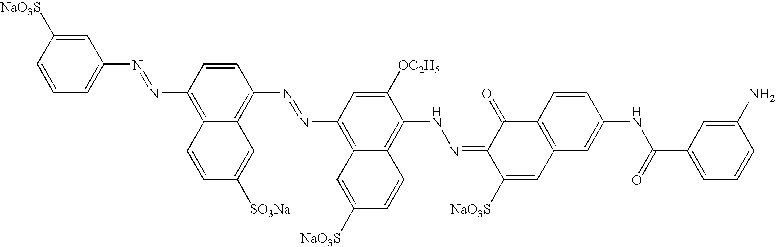 |

The polarizing dye solution also includes an activator that facilitates proper alignment the dye molecules on the brushed or microgrooved surfaces of the substrate to achieve the polarization effect. The activator is a non-ionic surfactant and, in one embodiment, comprises at least one of poly(ethoxylated)alkylphenols, poly(ethoxylated)nonylphenols, and combinations thereof.

A method of making a polarizing article having improved polarization efficiency is also provided. A light transmitting substrate is first provided. The substrate has at least one surface, and may have any shape that is suitable for the final application of the article. The surface may be either planar or contoured. For example, the substrate may be a planar sheet, a cylindrical blank of varying thickness, or, in the case of ophthalmic products such as prescription lenses, a blank having at least one of a concave and convex surface. The light transmitting substrate may, in various embodiments, be photochromic, colored, or colorless. In one embodiment, the surface of the substrate may be coated with a silica layer.

A light-transmitting substrate can be either an inorganic glass substrate or an organic polymer (plastic) substrate, such as those known in the art of ophthalmic lenses and optics. Examples of inorganic glasses that are suitable for use as a substrate include, but are not limited to, alkaline earth aluminosilicate glasses, boroaluminosilicate glasses, doped and undoped fused silica glasses, transparent glass-ceramic materials, crystalline materials such as CaF₂ and MgF₂, and the like. Non-limiting examples of organic polymers that are suitable for the light-transmitting substrate include polyamides, polyesters, polyimides, polysulfones, polycarbonates, polyurethanes, polyurethane-ureas, polyolefins, phenol resins, epoxy resins, homopolymers and copolymers of mono or poly-functional (meth)acrylate, cellulose acetate, cellulose triacetate, cellulose acetate butyrate, cellulose acetate propionate, polyvinyl(acetate), poly(vinyl alcohol), poly(vinyl chloride) and the like.

In those embodiments in which the light-transmitting substrate is an organic polymer, a silica layer may be deposited on the surface to be coated by the polarizing dye solution. The presence of the silica layer improves adhesion of the polarizing dye solution and resulting polarizing coating to the substrate. The silica layer may comprise a stoichiometric, such as SiO₂ or SiO, or a non-stoichiometric (i.e., oxygen-deficient or oxygen-rich) oxide, such as SiO_{y}, where 0.5≦y≦3. The silica layer has a thickness of less than about 10 μm.

In some embodiments, the stoichiometric ratio of SiO can be less than about 5 μm, and, in other embodiments, this ration can be less than about 1 μm. Such silica layers may be deposited on the substrate by physical or chemical vapor deposition methods known in the art, including plasma or ion-beam sputtering, plasma enhanced chemical vapor deposition (PECVD), low pressure chemical vapor deposition (LPCVD), and the like. In particular, PECVD is one exemplary method for depositing the silica layer on an organic polymer substrate, as this deposition technique allows the silica layer to be deposited at much lower temperatures (typically between about 200° C. and about 400° C.) than other chemical vapor deposition techniques.

A polarizing coating is formed in situ on at least one surface of the light-transmitting substrate by applying the aqueous polarizing dye solution to at least one surface of the substrate. The polarizing dye solution may, in one embodiment, be applied to at least one of a concave surface and a convex surface of the substrate to form the polarizing coating. In those embodiments where a plurality of microgrooves are formed on a surface of the substrate, the polarizing dye solution is applied to the surface having the microgrooves to form the polarized coating, where at least a portion of the polarizing azoic dyes collect in the microgrooves. In some embodiments, the surface having the plurality of microgrooves is a convex surface of the substrate, although, in other embodiments, the surface having the plurality of microgrooves may be a concave surface, as described hereinabove. The surface of the substrate is coated using those methods known in the art, such as, but not limited to, spin coating, dip coating, spray coating, flow coating, web coating, and the like. In those instances where the polarizing dye solution is deposited on the surface of the substrate by spin coating, for example, the drying of the dye solution is controlled by the spinning speed, and temperature and humidity in the chamber in which the coating step is carried out. Haze and polarization efficiency may be measured after drying.

Depending on the final application—for example, whether the particle is a prescription eyeglass lens or a sunglass lens—the polarizing dye solution may be deposited on either a front, convex surface or a back, concave surface. For prescription lenses, the polarizing dye solution is applied to the convex surface of the lens to allow further finishing of the concave surface of the substrate.

The deposited polarizing coating or layer can be water-soluble. It can be for the coating to be insolubilized (i.e., made insoluble) and immobilized on the substrate and, in particular, in the plurality of microgrooves (when present). The result of such insolubilization is the precipitation of the polarizing azoic dye molecules as inorganic salts that have low solubility in water at room temperature. The polarizing azoic dye molecules can be insolubilized by washing the polarizing coating with an aqueous dispersion or solution of at least one metal salt, usually followed by rinsing with deionized water. Such salts may be selected from those salts, such as aluminum salts, iron salts, chromium salts, calcium salts, magnesium salts, barium salts, and the like, that are used in the textile industry to insolubilize dyes in water. In one embodiment, aqueous solutions of chloride salts such as, aluminum chloride (AlCl₃), barium chloride (BaCl₂), cadmium chloride (CdCl₂), zinc chloride (ZnCl₂), tin chloride (SnCl₂), and the like are used to insolubilize the polarizing azoic dyes in the coating. In one particular embodiment, either AlCl₃ or ZnCl₂ may be used, due to their low toxicity. The aqueous solution used in the insolubilization step may also include at least one of buffers, acids, and multiple salts or bases of various metals. One example of an aqueous dispersion or solution used for such insolubilization is a solution or dispersion comprising aluminum chloride, magnesium hydroxide (Mg(OH)₂), and calcium hydroxide (Ca(OH)₂), the solution having a pH of about 4.

A polarizing article may be an eyeglass lens, sunglass lens, or the like. The polarizing article comprises a light-transmitting substrate and a polarizing coating disposed on at least one surface of the light-transmitting substrate. The polarizing article may also include additional coatings or layers that are known in the art. Such coatings or layers include, but are not limited to, adhesion or adhesion-promoting, hardcoat or anti-scratch, anti-reflective coatings or layers, and the like.

In one embodiment, the polarizing article has a polarization efficiency of at least about 98% and a haze, as determined by ASTM Method D 1003-07 of less than or equal to about 1.0% and, in another embodiment, a polarization efficiency of at least about 99% and a haze of less than about 0.30%. In another embodiment, the polarizing coating of the polarizing article is substantially free of micro-cracks and/or micro-crazing. In another embodiment, the polarizing article has environmental stability and scratch resistance.

### EXAMPLES

For each of the examples described herein, the light-transmitting substrates were prepared and coated with polarizing films.

Substrates were either glass lenses or plastic lenses coated with a silica layer having a convex surface. The convex surface of the substrate was brushed using a spherical polyether foam brush that has been soaked in a water-based alumina slurry. The contact time of the lens with the brush was adapted to the type of material and to the base (radius of curvature) of the lens. The lens then was carefully rinsed with de-ionized water to remove any residue.

The aqueous polarizing dye solution was spin-coated on the convex side of the lens inside a deposition chamber. Drying of the dye solution was controlled by the spinning speed, temperature and humidity in the deposition chamber. Haze and polarization efficiency were measured after the deposited polarizing dye was dried with either compressed nitrogen or air.

In order to protect the water soluble dye layer, the coated lenses were dipped in an aqueous aluminum chloride solution to insolubilize the polarizing dye, and then rinsed in de-ionized water. Haze, polarization efficiency, and level of cracking in the layer were measured after the silane treatment and curing. The level of cracking was determined using “grazing light (observation with an extended grazing light source),” “grazing micro-crazing (observation with a grazing fiber spotlight),” and “direct micro-crazing (observation with a direct fiber spotlight)”.

“Optical performance” was determined by measuring the parallel transmittance and perpendicular transmittance using a visible spectrophotometer and a polarizer. The Polarization efficiency was calculated using the following formula: P_{eff.}=100×[(Tₚₐᵣₐₗₗₑₗ−T_{perpendicular})/(Tₚₐᵣₐₗₗₑₗ+T_{perpendicular})].

“Hot-water resistance” and “moisture resistance” were evaluated by soaking the polarizing lenses for 3 hours in hot water at 90° C. The optical properties were checked and adhesion evaluated as well with the adhesive tape test but without scoring the surface.

“Adhesion” was evaluated before and after hot water test using a modified crosshatch ASTM D3359 adhesion test: In sum, the surface of the anti-scratch coating was scored using a razor blade. The spacing between cuts was about 1 mm and the scored pattern consists of 10×10 cuts. Adhesion was then evaluated by applying a 3M 610 pressure sensitive adhesive tape over cuts made in the coating and the tape was then quickly peeled off. After the tape had been pulled off, the cut area was inspected and rated.

An artificial acidic sweat test also was conducted. The substrate was soaked for 5 hours in an aqueous solution at 50° C. sodium chloride solution. After the substrate was dried, adhesion was evaluated using the tape test and the lens was visually inspected. A lens was rated “failed” when low adhesion or cosmetic defects were observed.

### Examples 1 and 2 and Comparative Examples 1 and 2

Preparation and characterization of polarized coatings prepared using polarizing dye solutions.

In Examples 1 and 2, the substrates were dipped in an aqueous solution of 3-aminopropyltriethoxysilane (concentration of 10% by weight in the solution) for 15 minutes at 50 degrees Celsius. After the substrates were dried and cured, the then dipped in a 10 wt % glycidoxypropyltrimethoxysilane solution for 30 minutes at room temperature. The substrate in Example 1 is a plastic substrate (SiO₂) and the substrate in Example 2 is a mineral substrate. Properties measured after dye deposition, insolubilization, treatment with silane, and curing of the lens coated with the polarizing dye solution prepared using HCl are listed in Table 2 (below).

In Comparative Examples 1 and 2, the procedure for Examples 1 and 2 was followed except the substrates were dipped in an aqueous solution of 3-aminopropyltriethoxysilane (concentration of 10% by weight in the solution) for 15 minutes at 20 degrees Celsius.

Properties measured after dye deposition, insolubilization, treatment with silane, and curing of the coated lens as shown in Table 2.

TABLE 2

| | | Example 1 | Example 2 |
|---|---|---|---|
| With Silane | ASTM haze (%) | 0.31 | 0.33 |
| Treatment | Polarization | 99.04 | 98.73 |
| | efficiency (%) | | |
| | Transmission (%) | 34.1 | 16.1 |
| | Adhesion after Hot | Pass | Pass |
| | Water | | |
| | Adhesion after Hot | Pass | Pass |
| | Water | | |
| | Artificial Acid Sweat | Pass | Pass |
| | Test | | |
| | Bubbling | Pass | Pass |
| | | Comparative | Comparative |
| | | Example 1 | Example 2 |
| Without Silane | ASTM haze (%) | 0.25 | 0.25 |
| Treatment | Polarization | 98.95 | 98.98 |
| | efficiency (%) | | |
| | Transmission (%) | 34.0 | 16.0 |
| | Adhesion before Hot | Pass | Pass |
| | Water | | |
| | Adhesion after Hot | Fail | Fail |
| | Water | | |
| | Artificial Acid Sweat | Pass | Pass |
| | Test | | |
| | Bubbling | Pass | Pass |

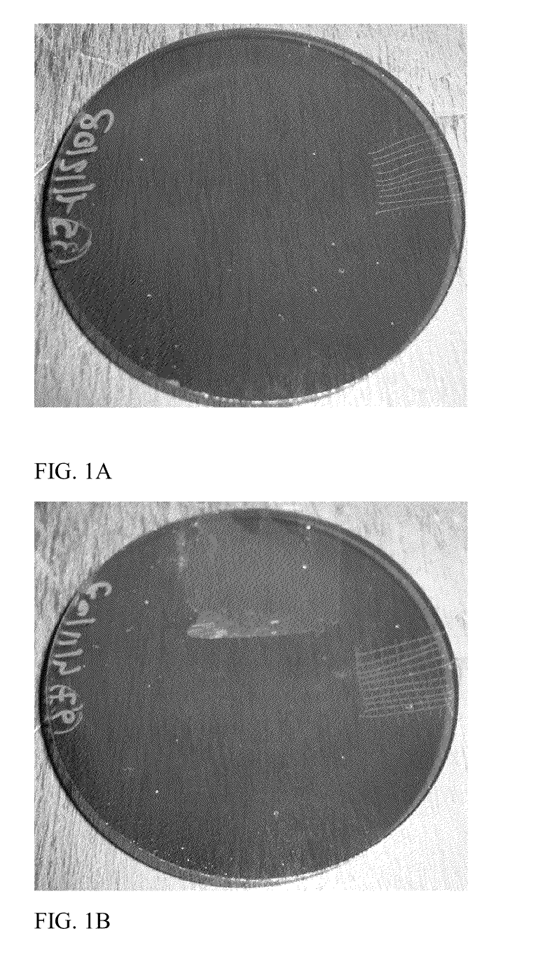

Further, FIG. 1A is an image of a polarized lens prepared using the procedure of Example 1; and shows that a polarized lens passed the adhesion test in that delamination does not occur. FIG. 1B is an image of a polarized lens prepared using the procedure of Comparative Example 2, and shows that a polarized lens failed the adhesion test in that delamination does occur.

### Examples 3-6

Various polarized lenses were prepared using a combination of dyes and were treated with a silane according to the procedure described in Examples 1 and 2.

In Example 3, the substrate was prepared using a commercial polarizing dye mixture. Specifically, the dye solution was a mixture of vari-Light Solution No. 2S supplied by Sterling Optics Inc. (1418 North Main Street US 25, PO Box 154 Williamstown, Ky. 41097, USA) and 1% wt of activator (a water based solution of a mixture of non-ionic surfactants)

In Example 4, the substrate was prepared using a dye mixture based on Direct Blue 67, Direct Orange 72 and Direct Green 27. The dye solution is a mixture of an ammonium salt of the azoic dye Direct Blue 67, an ammonium salt of the azoic dye Direct Orange 72, an ammonium salt of the azoic dye Direct Green 27, a crude sodium salt of the acid dye Acid Brown 4, de-ionized water, and 1% wt of activator (a water based solution of a mixture of non-ionic surfactants). The weight ratio of the dry salt to solution are were as follows: the ratio of ammonium salt of the azoic dye Direct Blue 67 to solution was 0.75%; the ratio of ammonium salt of the azoic dye Direct Orange 72 to solution was 1.00%; the ratio of ammonium salt of the azoic dye Direct Green 27 to solution was 2.25%; and the ratio of Acid Brown 4 to solution was 0.08%.

In Example 5, the substrate was prepared using a dye mixture based on Direct Blue 67. The dye solution was a mixture of an ammonium salt of the azoic dye Direct Blue 67, crude sodium salt of the acid dye Acid Brown 4, de-ionized water, and 1% wt of activator (a water based solution of a mixture of non-ionic surfactants). The weight ratio of the dry dye salt to solution was as follows: the ratio of ammonium salt of the azoic dye Direct Blue 67 to solution was 2.80%; and the ratio of acid Brown 4 to solution was 0.056%.

In Example 6, the substrate was prepared using a dye mixture based on Direct Blue 67 and Direct Green 26. The dye solution was a mixture of an ammonium salt of the azoic dye Direct Blue 67, an ammonium salt of the azoic dye Direct Green 26, crude sodium salt of the acid dye Acid Brown 4, de-ionized water, and 1% wt of activator (a water based solution of a mixture of non-ionic surfactants). The weight ratio of the dry dye salt to the solution was as follows: the ratio of ammonium salt of the azoic dye Direct Blue 67 to solution was 2.280%; the ratio of ammonium salt of the azoic dye Direct Green 26 to solution was 1.520%; and the ratio of acid Brown 4 to solution was 0.076%.

After silane treatment and curing, the haze, polarization efficiency and level of cracks in the layer (“grazing light”: observation with extended grazing light source; “grazing micro-crazing”: observation with grazing fiber spotlight; and “direct micro-crazing”: observation with direct fiber spotlight) are measured. The results are shown in Table 3.

TABLE 3

| | | Example 3 | Example 4 | Example 5 | Example 6 |
|---|---|---|---|---|---|
| Afler dye | ASTM haze (%) | 0.27 | 0.53 | 0.36 | 0.26 |
| deposition | Mean transmission | 28.8 | 29.4 | 31.4 | 25.7 |
| | (%) | | | | |
| | Polarization | 99.36 | 99.54 | 99.45 | 99.27 |
| | efficiency (%) | | | | |
| | Grazing light | 0 | 0 | 0 | 0 |
| | (Arbitrary Units (AU)) | | | | |
| | Grazing Micro- | 0 | 0 | 0 | 0 |
| | crazing (AU) | | | | |
| | Parallel Direct | 0 | 0 | 0 | 0 |
| | Micro-crazing (AU) | | | | |
| | Orthogonal Direct | 0 | 0 | 0 | 0 |
| | Micro-crazing (AU) | | | | |
| Afler silane | ASTM haze (%) | 0.43 | 0.61 | 0.37 | 0.30 |
| treatment and | Mean transmission | 28.9 | 30.2 | 34.1 | 25.4 |
| curing | (%) | | | | |
| | Polarization | 98.2 | 98.7 | 99.1 | 99.1 |
| | efficiency (%) | | | | |
| | Grazing light | 0.1 | 0.6 | 0 | 0 |
| | (Arbitrary Units (AU)) | | | | |
| | Grazing Micro- | 0.1 | 0.5 | 0 | 0 |
| | crazing (AU) | | | | |
| | Parallel Direct | 0 | 0.6 | 0 | 0.1 |
| | Micro-crazing (AU) | | | | |
| | Orthogonal Direct | 0 | 0 | 0 | 0.1 |
| | Micro-crazing (AU) | | | | |

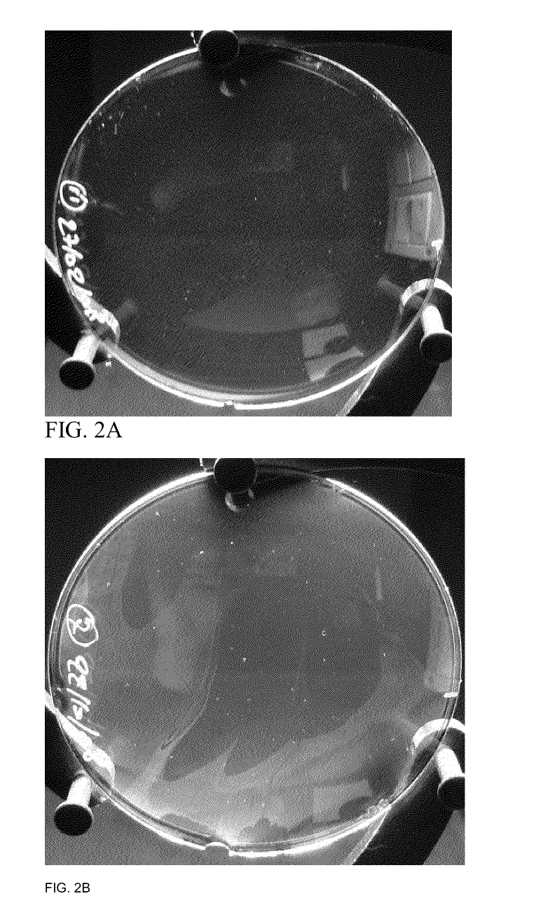

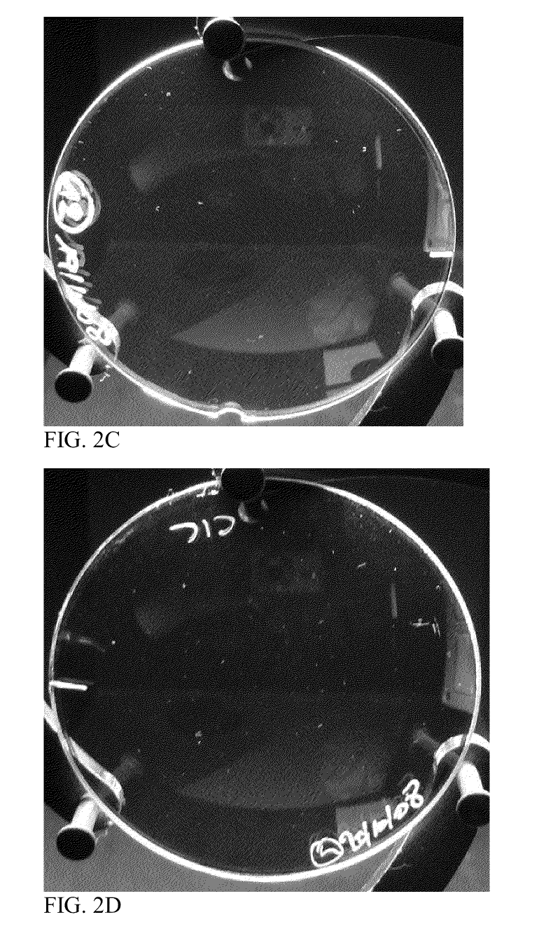

Images of polarized lenses prepared using the polarizing dye solution discussed in the examples are shown in FIGS. 2A, 2B, 2C, and 2D. The lenses have been illuminated with a fiber light spot.

The above detailed description, and the examples, are for illustrative purposes only and are not intended to limit the scope and spirit of the disclosure, and its equivalents, as defined by the appended claims. One skilled in the art will recognize that many variations can be made to the embodiments disclosed in this specification without departing from the scope and spirit of the disclosure.

What is claimed is:

1. A method for preparing a polarizing substrate disposed on a surface of the substrate, the method comprising:
contacting the substrate with a first solution comprising a first organic silane, wherein the first organic silane comprises one or more reactive functional groups; and the first solution is applied to the substrate, and the first solution is at a temperature greater than about 20 degrees Celsius.

2. The method as claimed in claim 1, wherein the first solution is at a temperature greater than about 30 degrees Celsius.

3. The method as claimed in claim 1, wherein the functional group is selected from the group consisting of an amino group, a thiol group, a hydroxyl group, a carboxyl group, an acrylic acid, an organic and inorganic acid, an ester, an anhydride, an aldehyde, an epoxide, derivatives or salts thereof, and combinations thereof.

4. The method as claimed in claim 1, wherein the first organic silane comprises a straight or branched-chain aminosilane, aminoalkoxysilane, aminoalkylsilane, aminoarylsilane, aminoaryloxysilane, derivatives thereof, or salts thereof.

5. The method as claimed in claim 1, wherein the first organic silane comprises 3-aminopropyl trimethoxysilane, 3-aminopropyl triethoxysilane, N-(beta-aminoethyl)-3-aminopropyl trimethoxysilane, N-(beta-aminoethyl)-3-aminopropyl triethoxysilane, N′-(beta-aminoethyl)-3-aminopropyl methoxysilane, or aminopropylsilsesquixoane.

6. The method as claimed in claim 1, wherein the first solution comprises an aqueous solution of the first organic silane, wherein the first organic silane is from about 2 to about 40% by weight of the solution.

7. The method as claimed in claim 1, wherein the substrate is contacted by the first solution by dipping or spraying.

8. The method as claimed in claim 1, further comprising,
contacting the substrate with a second solution comprising a second organic silane after contacting the substrate with the first solution, wherein the first organic silane and second organic silane are the same or different compound.

9. The method as claimed in claim 1, wherein the dye layer is formed by treating the substrate with a dye solution consisting essentially of Direct Blue 67.

10. A method for preparing a polarizing article comprising:
providing a light-transmitting substrate;
providing an aqueous polarizing dye solution;
coating at least one surface of the substrate with the aqueous polarizing dye solution to form a dye layer;
insolubilizing the polarizing coating with a stabilizing solution to provide a insolubilized polarizing coating;
treating the insolubilized polarizing coating with a first silane solution at a temperature greater than room temperature to provide a solution treated polarizing coating; and
curing the solution treated polarizing coating to form the polarizing article.

11. The method as claimed in claim 10, further comprising,
contacting the substrate with a second silane solution comprising an organic silane after contacting the substrate with the first silane solution.

12. The method as claimed in claim 10, further comprising,
applying a primer to the substrate after contacting the substrate with the first silane solution.

13. The method as claimed in claim 10, further comprising,
applying a primer to the substrate after contacting the substrate with the first silane solution and applying a hardcoat to the substrate after applying the primer.

14. The method as claimed in claim 10, wherein the dye layer is produced by (a) applying the dye solution to the substrate followed by (b) applying the stabilizing solution to the substrate.

15. The method as claimed in claim 13, wherein the dye solution comprises a single polarizing dye.

16. The method as claimed in claim 15, wherein the dye is either Direct Blue 67 or Direct Green 27.

17. The method as claimed in claim 15, wherein the dye consists essentially of Direct Blue 67.

18. The method as claimed in claim 15, wherein the dye has a solubility in water of less than about 5% at room temperature.

19. A polarizing article produced by the method as claimed in claim 10.

20. The method as claimed in claim 19, wherein coating at least one surface of the substrate with the aqueous polarizing dye solution comprises spin-coating the dye solution onto the substrate.
